(19) United States
(12) Patent Application Publication
(10) Pub. No.: US 2024/0286971 A1
(43) Pub. Date: Aug. 29, 2024

(54) ROSIN-BASED SUSTAINABLE DUST, CAKING, AND MOISTURE CONTROL COATINGS

(71) Applicant: ArrMaz Products Inc., Mulberry, FL (US)

(72) Inventors: Jose FERNANDEZ, Mulberry, FL (US); Lucas R. MOORE, Mulberry, FL (US); Paul A. WILLIAMS, Mulberry, FL (US); Christina KONECKI, Mulberry, FL (US)

(21) Appl. No.: 18/572,839

(22) PCT Filed: Jun. 16, 2022
(86) PCT No.: PCT/US2022/033700

§ 371 Date: Dec. 21, 2023

Related U.S. Application Data
(60) Provisional application No. 63/216,060, filed on Jun. 29, 2021.

(51) Int. Cl. C05G 5/30; B01J 2/30

(52) U.S. Cl. CPC C05G 5/38; B01J 2/30

(57) ABSTRACT

A rosin-based sustainable dust and moisture control coating. The coating may be primarily comprised of rosin, and may further comprise NABS, soybean oil, and/or other sustainable oils.

### CROSS REFERENCE

This application is based on and claims priority to U.S. Provisional Patent Application No. 63/216,060 filed Jun. 29, 2021.

### BACKGROUND OF THE INVENTION

### Field of the Invention

This invention relates generally to fertilizer coatings, and more particularly, but not by way of limitation, rosin-based sustainable dust, caking, and moisture control coatings.

### Description of the Related Art

Plants require a wide range of nutrients for optimal crop growth and fruit production. Nutrients come from the air or through adsorption through the root. Continuously farmed soils become depleted of essential nutrients. To maintain soil fertility and maximize crop production, nutrients must be added by way of fertilizers. Solid fertilizers are typically hygroscopic and are often very dusty, and many are very hygroscopic. As such, fertilizers benefit from the application of coatings that control dust and moisture absorption and that reduce caking.

Coatings have been applied to control these handling challenges of fertilizer for many years. However, they have dominantly been produced from byproducts from petroleum processing. A push to move to the more sustainable supply chains for the coatings have typically led to lower-performing products that are generally sugar based. The coatings usually do not compare in performance, nor do they typically maintain the required protection for the long fertilizer supply chain.

Currently, rosin is not used in fertilizer because it is difficult to handle. It has very poor heat transfer and the viscosity is greater than 35,000 cP at 230° F. In addition, it is brittle and will crumble if applied as a fertilizer coating.

Based on the foregoing, it is desirable to provide a coating that provides effective dust control, caking reduction, and reduction in the rate of moisture adsorption from hygroscopic substrates, while also being from a sustainable supply chain.

In particular, it is desirable to provide such a coating that is rosin-based.

It is further desirable to provide a novel method of producing such a rosin-based coating.

### SUMMARY OF THE INVENTION

In general, in a first aspect, the invention relates to a dust and moisture control coating for fertilizer, the coating comprising rosin and a cutter. The coating may comprise 50% to 70% rosin and 50% to 30% cutter, or more preferably 60% to 65% rosin and 40% to 35% cutter. The rosin may be tall oil rosin, gum rosin, wood rosin, or any combination thereof. The cutter may comprise natural alcohol bottoms (NABS), mineral oil, soybean oil, chufa oil, waxy naturally occurring substance like the residue or bottoms of glycerin production, the residue or bottoms of fatty acid production, or any vegetable wax, and/or other sustainable oils, or a combination thereof. In particular, the coating may comprise 60% to 65% rosin, 10% natural alcohol bottoms, and 5% to 10% soybean oil. The initial cutter may have a flash point above 250° F. Additionally or alternately, the cutter may comprise a primary cutter with a flash point above 250° F. and a secondary cutter with a flash point below 250° F. To enhance anticaking performances, 1 to 30% of an amine, fatty acid, phosphate ester, or a wax may be added. In particular, the previously mentioned coating may contain 15 to 20% of a combination of stearyl amine, octadecyl phosphate ester, stearic acid, or palm wax.

In a second aspect, the invention relates to a method of producing fertilizer with a sustainable dust and moisture control coating, the method comprising solubilizing rosin with a cutter to produce a coating material and applying the coating material to a fertilizer substrate. Solubilizing the rosin with the cutter may comprise mixing the rosin and the cutter. Mixing the rosin and the cutter may occur in a steam jacketed static mixer at a minimum temperature of 260° F. Applying the coating material to the fertilizer substrate may comprise combining the coating material and the fertilizer substrate in a blending tank to at least partially coat the fertilizer substrate with the coating material. The coating material may have a suitable viscosity to be pumped into a blending tank or a coating drum.

The coating may comprise 50% to 70% rosin and 50% to 30% cutter, or more preferably 60% to 65% rosin and 40% to 35% cutter. The cutter may comprise natural alcohol bottoms (NABS), soybean oil, chufa oil, waxy naturally occurring substance like the residue or bottoms of glycerin production, the residue or bottoms of fatty acid production, or any vegetable wax, and/or other sustainable oils, or a combination thereof. In particular, the coating may comprise 60% to 65% rosin, 10% natural alcohol bottoms, and 5% to 10% soybean oil. The cutter may have a flash point above 250° F. Additionally or alternately, the cutter may comprise a primary cutter with a flash point above 250° F. and a secondary cutter with a flash point below 250° F.

### DETAILED DESCRIPTION OF THE INVENTION

The devices and methods discussed herein are merely illustrative of specific manners in which to make and use this invention and are not to be interpreted as limiting in scope.

While the devices and methods have been described with a certain degree of particularity, it is to be noted that many modifications may be made in the details of the construction and the arrangement of the devices and components without departing from the spirit and scope of this disclosure. It is understood that the devices and methods are not limited to the embodiments set forth herein for purposes of exemplification.

In general, in a first aspect, the invention relates to a rosin-based sustainable dust, caking, and moisture control coating. The coating may be primarily comprised of rosin. The rosin may be tall oil rosin, gum rosin, wood rosin, or any combination thereof. The rosin may specifically be derived from pine trees, or may be any other desired rosin. The coating may further comprise a cutter. The cutter may have a flash point between 300 and 350° F. In particular, the cutter may be natural alcohol bottoms (NABS), mineral oil, soybean oil, chufa oil, waxy naturally occurring substance like the residue or bottoms of glycerin production, the residue or bottoms of fatty acid production, or any vegetable wax, and/or other sustainable oils, or a combination thereof. For example, the coating may comprise 65% rosin, 30% NABS, and 5% soybean oil. In another example, the coating may comprise 60% rosin, 30% NABS, and 10% soybean oil. In general, the coating may comprise at least 10% rosin and no more than 90% cutter, which may be a single type of cutter or a combination of multiple types of cutters.

To enhance anticaking performances, 1 to 30% of an amine, fatty acid, phosphate ester, or a wax may be added. In particular, the previously mentioned coating can contain 15 to 20% of a combination of stearyl amine, octadecyl phosphate ester, stearic acid, or palm wax.

Rosin is typically extremely difficult to manage and handle. Thus, the invention further relates to a method for handling and cutting the rosin to a viscosity that allows the rosin to be homogenously applied to a fertilizer substrate. In particular, the rosin may be solubilized with the cutter to a suitable viscosity to be pumped into a blending tank. The rosin and the cutter may be mixed in a steam jacketed static mixer at a minimum temperature of 260° F. to produce the coating. The coating may then be applied to the fertilizer substrate. For example, the coating and the fertilizer substrate may be combined in a blending tank to at least partially coat the fertilizer substrate with the coating.

While the temperature required to manage rosin without a high flash point solvent is approximately 260° F., solubilizing the rosin in the presence of oils with high palmitic acid content, fatty acids, and tall oils may reduce the temperature in which the rosin may be handled to below 250° F., and more specifically to approximately 195 to 220° F. Potential flashing of low-boiling cutters may be a concern; thus, biodiesel, which has a low flash point, may not be used as a primary cutter. It may, however, be used as a secondary cutter after a high flash oil is used to solubilize the rosin. Rosin concentration may be maintained below 70% because the solubilized rosin may be flowable and capable of being pumped below this concentration, while loss of power may cause a hard crystalline buildup in the lines if the rosin solubility is greater than 70%.

### EXAMPLE

During testing, a coating comprising 65% rosin, 30% NABS, and 5% soybean oil was prepared according to the above-referenced method and applied to a monoammonium phosphate (MAP) fertilizer at a rate of 8 lbs./T (pounds/ton). Also tested were uncoated MAP as a control; MAP coated with tall oil pitch; MAP coated with a coating comprising tall oil rosin, tall oil heads, and NABS; and MAP coated with refined tall oil pitch. As shown in the following chart, the novel coating of rosin, NABS, and soybean oil outperformed the other coatings both initially and after one week.

| | | | Initial | Week # 1 | Total | Total Dust |
|---|---|---|---|---|---|---|
| | | DOSAGE | Dust | | Cumulative | Reduction |
| SAMPLE | | RATE | (ppm) | | Dust (ppm) | (%) |
| Modified | Control | N/A | 823 | 1000 | 1000 | 0% |
| MAP | Tall oil | 8 Lbs/T | 241.7 | 335.0 | 335 | 66% |
| | pitch | | | | | |
| | Tall oil | | 130.0 | 226.7 | 226.7 | 77% |
| | Rosin and | | | | | |
| | Head, | | | | | |
| | NABS | | | | | |
| | Rosin, | | 83.3 | 143.3 | 143.3 | 86% |
| | NABS, and | | | | | |
| | Soy Bean | | | | | |
| | Oil | | | | | |
| | Refined | | 186.7 | 297.7 | 297.7 | 70% |
| | Tall Oil | | | | | |
| | Pitch | | | | | |

Whereas, the devices and methods have been described in relation to the drawings and claims, it should be understood that other and further modifications, apart from those shown or suggested herein, may be made within the spirit and scope of this invention.

1. A dust, caking, and moisture control coating for fertilizer, the coating comprising rosin and a cutter.

2. The dust, caking, and moisture control coating of claim 1 where the coating comprises 10 percent to 70 percent rosin and 90 percent to 30 percent cutter.

3. The dust, caking, and moisture control coating of claim 1 where the coating comprises 60 percent to 65 percent rosin and 40 percent to 35 percent cutter.

4. The dust and moisture control coating of claim 1 further comprising 1 to 30 percent of an amine, fatty acid, phosphate ester, or a wax, or the combination thereof.

5. The dust, caking, and moisture control coating of claim 1 where the cutter comprises natural alcohol bottoms (NABS), mineral oil, soybean oil, chufa oil, waxy naturally occurring substance like the residue or bottoms of glycerin production, the residue or bottoms of fatty acid production, or any vegetable wax, and/or other sustainable oils, or a combination thereof.

6. The dust, caking, and moisture control coating of claim 1 where the coating comprises 60 percent to 65 percent rosin, 10 percent natural alcohol bottoms, and 5 percent to 10 percent soybean oil.

7. The dust, caking and moisture control coating of claim 1 where the primary cutter has a flash point above 250 degrees Fahrenheit.

8. The dust and moisture control coating of anyone of claim 1 where the cutter comprises a primary cutter with a flash point above 250 degrees Fahrenheit and a secondary cutter with a flash point below 250 degrees Fahrenheit.

9. A method of producing fertilizer with a sustainable dust and moisture control coating, the method comprising: solubilizing rosin with a cutter to produce a coating material; and applying the coating material to a fertilizer substrate.

10. The method of claim 9 where solubilizing the rosin with the cutter comprises mixing the rosin and the cutter.

11. The method of claim 10 where mixing the rosin and the cutter occurs in a steam jacketed static mixer at a minimum temperature of 260 degrees Fahrenheit.

12. The method of claim 9 where applying the coating material to the fertilizer substrate comprises combining the coating material and the fertilizer substrate in a blending tank to at least partially coat the fertilizer substrate with the coating material.

13. The method of claim 9 where the coating material has a sufficient viscosity to be pumped into a blending tank.

14. The method of claim 9 where the coating material comprises 10 percent to 70 percent rosin and 90 percent to 30 percent cutter.

15. The method of claim 14 where the coating material comprises 60 percent to 65 percent rosin and 40 percent to 35 percent cutter.

16. The method of claim 9 where the cutter comprises natural alcohol bottoms (NABS), mineral oil, soybean oil, chufa oil, waxy naturally occurring substance like the residue or bottoms of glycerin production, the residue or bottoms of fatty acid production, or any vegetable wax, and/or other sustainable oils, or a combination thereof.

17. The method of claim 9 where the coating comprises 60 percent to 65 percent rosin, 10 percent natural alcohol bottoms, and 5 percent to 10 percent soybean oil.

18. The method of claim 9 where the cutter has a flash point above 250 degrees Fahrenheit.

19. The method of claim 9 where the cutter comprises a primary cutter with a flash point above 250 degrees Fahrenheit and a secondary cutter with a flash point below 250 degrees Fahrenheit.
